(19) United States
(12) Patent Application Publication
(10) Pub. No.: US 2013/0257660 A1
(43) Pub. Date: Oct. 3, 2013

(54) COMMUNICATION DEVICE WITH CONDUCTIVE HOUSING AND ANTENNA ELEMENT THEREIN

(71) Applicants: Kin-Lu WONG, Kaohsiung City (TW); Li-Yu CHEN, Kaohsiung City (TW)

(72) Inventors: Kin-Lu WONG, Kaohsiung City (TW); Li-Yu CHEN, Kaohsiung City (TW)

(73) Assignee: ACER INCORPORATED, Taipei Hsien (TW)

(21) Appl. No.: 13/535,229

(22) Filed: Jun. 27, 2012

(30) Foreign Application Priority Data
Apr. 2, 2012 (TW) 101111636

(51) Int. Cl. H01Q 1/24

(52) U.S. Cl. 343/702

(57) ABSTRACT

A communication device with an upper cover and a lower cover including a conductive housing and an antenna element is provided. The conductive housing includes a first conductive surface and a second conductive surface. The first conductive surface is disposed on a surface of the upper cover. The second conductive surface is disposed on a surface of the lower cover. The first conductive surface and the second conductive surface are electrically coupled to each other, and a first edge of the first conductive surface is adjacent to a second edge of the second conductive surface. The antenna element is substantially disposed between the first edge and the second edge, and is excited to form a first band and a second band. The antenna element includes a ground element, a first radiating element, and a second radiating element.

### CROSS REFERENCE TO RELATED APPLICATIONS

This Application claims priority of Taiwan Patent Application No. 101111636 filed on Apr. 2, 2012, the entirety of which is incorporated by reference herein.

### BACKGROUND OF THE INVENTION

1. Field of the Invention

The disclosure generally relates to a communication device, and more particularly, relates to a communication device with a conductive housing and an antenna element therein.

2. Description of the Related Art

With recent rapid development in wireless communication technology, a wide variety of wireless communication products have been developed and promoted. The most popular are mobile communication products. For mobile communication products, the current trend is toward thin and light appearances. Nowadays, beautiful appearances and solid devices are necessary. Therefore, it is important to design a thin and light mobile communication device with a metal or conductive housing and an antenna element therein.

In prior art, antenna elements are disclosed; for example, U.S. Patent Publication No. 8,022,881 B2 “Multiband Antenna”. If the antenna element is applied to a communication device with a conductive metal housing (e.g., a notebook), a nonconductive antenna window should be formed in an upper cover of the conductive housing such that the appearance of the communication device is affected.

Basically, there is a need to provide a new communication device with a conductive housing and an antenna element therein, with the new communication device having a beautiful and thin appearance.

### BRIEF SUMMARY OF THE INVENTION

The invention is aimed to provide a communication device with a conductive housing and an antenna element therein. The antenna element is disposed between an upper cover and a lower cover of the communication device and is close to a hinge of the communication device. This not only eliminates an antenna window for the antenna element but also lets the communication device have a beautiful and thin appearance.

In one exemplary embodiment, the disclosure is directed to a communication device with an upper cover and a lower cover, comprising: a conductive housing comprising a first conductive surface and a second conductive surface, wherein the first conductive surface is disposed on a surface of the upper cover, the second conductive surface is disposed on a surface of the lower cover, the first conductive surface and the second conductive surface are coupled to each other, and a first edge of the first conductive surface is adjacent to a second edge of the second conductive surface; and an antenna element disposed substantially between the first edge and the second edge, wherein the antenna element is excited to form a first band and a second band, and the antenna element comprises: a ground element coupled to the second conductive surface; a first radiating element excited to generate at least one resonant mode in the second band, wherein an initial end of the first radiating element is coupled to a signal source; and a second radiating element, wherein one end of the second radiating element is an initial end coupled to the signal source and to the first radiating element, and the other end of the second radiating element is a grounding end coupled to the ground element such that the antenna element provides a closed resonant path excited to generate at least one resonant mode in the first band.

In an embodiment, the first and second radiating elements are disposed on a same plane. The first radiating element is a monopole antenna which is excited to form a wide second band (high frequency band), such as a 5.2/5.8 GHz (from 5150 MHz to 5825 MHz) WLAN (Wireless Local Area Network) band. The advantage of the first radiating element is its planar structure. The second radiating element forms a closed resonant path, and the total length of the closed resonant path is approximately equal to 0.5 wavelength of a frequency in the first band (low frequency band) such that the second radiating element is excited to form the wide first band, such as a 2.4 GHz (from 2400 MHz to 2484 MHz) WLAN band. The closed resonant path is configured to reduce mutual coupling between the antenna element and other adjacent antennas or adjacent metal elements. When the first radiating element is excited and operates in the 5.2/5.8 GHz WLAN band, the second radiating element is not excited. Therefore, the second radiating element may be seen as an extended ground portion of the ground element or as a shield metal element. The second radiating element is also configured to reduce mutual coupling between the first radiating element and other adjacent antennas or adjacent metal elements.

In an embodiment, a portion of the second conductive surface of the communication device is substantially perpendicular to a plane on which the lower cover is positioned. The first band and the second band of the antenna element each cover at least one communication band. The antenna element may be a planar antenna disposed on a surface of a dielectric substrate. In another embodiment, the surface of the dielectric substrate is a smooth curved surface. The antenna element is thin and flat, and the antenna element is suitable to be placed between the upper cover and the lower cover of the communication device, and to be close to the hinge of the communication device. The invention can maintain completeness of the conductive housing of the communication device.

### BRIEF DESCRIPTION OF DRAWINGS

The invention can be more fully understood by reading the subsequent detailed description and examples with references made to the accompanying drawings, wherein:

FIG. 1A is a diagram for illustrating a communication device according to a first embodiment of the invention;

FIG. 1B is a diagram for illustrating the communication device when an upper cover is substantially parallel to a lower cover according to the first embodiment of the invention;

FIG. 2 is a diagram for illustrating an antenna element of the communication device according to the first embodiment of the invention;

FIG. 3A is a diagram for illustrating return loss of the communication device as shown in FIG. 1A according to the first embodiment of the invention;

FIG. 3B is a diagram for illustrating return loss of the communication device as shown in FIG. 1B according to the first embodiment of the invention;

FIG. 4 is a diagram for illustrating an antenna element of the communication device according to a second embodiment of the invention; and

FIG. 5 is a diagram for illustrating an antenna element of the communication device according to a third embodiment of the invention.

### DETAILED DESCRIPTION OF THE INVENTION

In order to illustrate the foregoing and other purposes, features and advantages of the invention, the embodiments and figures thereof in the invention are shown in detail as follows.

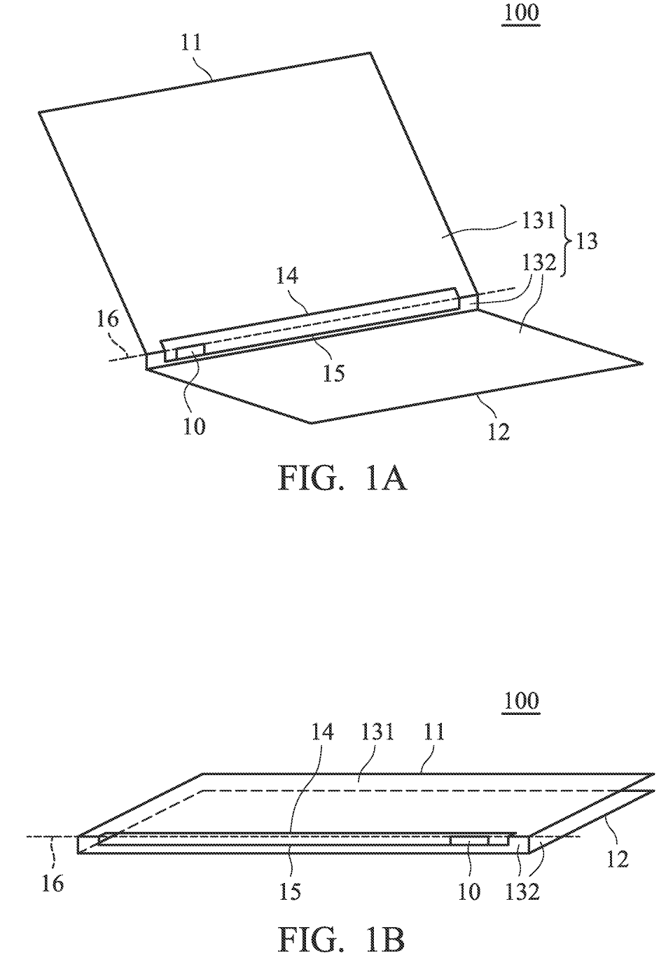

FIG. 1A is a diagram for illustrating a communication device 100 according to a first embodiment of the invention. In the embodiment, the communication device 100 has an upper cover 11 and a lower cover 12, and further comprises a conductive housing 13 and an antenna element 10. Note that even if the upper cover 11 and the lower cover 12 are each shown as a plane in FIG. 1A, the upper cover 11 and the lower cover 12 may each have a predetermined thickness. The conductive housing 13 comprises a first conductive surface 131 and a second conductive surface 132. The first conductive surface 131 is disposed on a surface of the upper cover 11, and the second conductive surface 132 is disposed on a surface of the lower cover 12. A portion of the second conductive surface 132 is substantially perpendicular to a plane on which the lower cover 12 is positioned. The first conductive surface 131 and the second conductive surface 132 are electrically coupled to each other, and a first edge 14 of the first conductive surface 131 is adjacent to a second edge 15 of the second conductive surface 132.

FIG. 1B is a diagram for illustrating the communication device 100 when the upper cover 11 is substantially parallel to the lower cover 12 according to the first embodiment of the invention. Note that in FIG. 1A, the communication device 100 is opened, and the upper cover 11 is away from the lower cover 12. As shown in FIG. 1B, the communication device 100 is closed according to the first embodiment, and the upper cover 11 is substantially parallel to the lower cover 12.

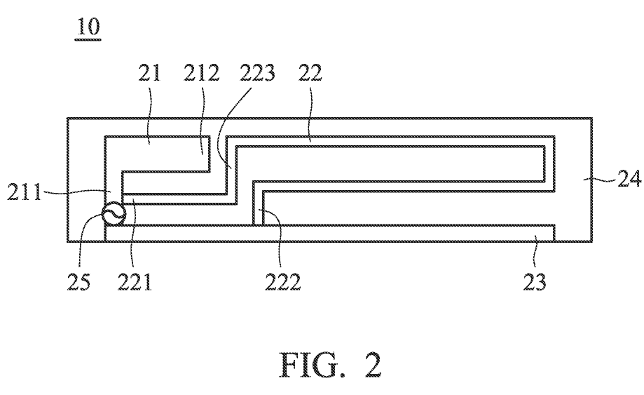

FIG. 2 is a diagram for illustrating the antenna element 10 of the communication device 100 according to the first embodiment of the invention. The antenna element 10 is disposed substantially between the first edge 14 of the first conductive surface 131 and the second edge 15 of the second conductive surface 132, and is close to a hinge 16 of the communication device 100. As shown in FIG. 2, the antenna element 10 comprises a ground element 23, a first radiating element 21, and a second radiating element 22. In an embodiment, the antenna element 10 is a planar antenna disposed on a surface of a dielectric substrate 24. The ground element 23 is electrically coupled to the second conductive surface 132 of the communication device 100. The first radiating element 21 is a monopole antenna which is excited to generate at least one resonant mode in a second band (high frequency band). An initial end 211 of the first radiating element 21 is electrically coupled to a signal source 25. One end of the second radiating element 22 is an initial end 221 which is electrically coupled to the signal source 25 and to the first radiating element 21. The other end of the second radiating element 22 is a grounding end 222 which is electrically coupled to the ground element 23 such that the antenna element 10 provides a closed resonant path which is excited to generate at least one resonant mode in a first band (low frequency band). Note that the first radiating element 21 is disposed outside the closed resonant path, and the first radiating element 21 substantially extends a distance away from the ground element 23 and then extends toward a portion 223 of the second radiating element 22, wherein the portion 223 of the second radiating element 22 is substantially perpendicular to the ground element 23. In a preferred embodiment, the first radiating element 21 and the second radiating element 22 are disposed on a same plane, but the invention is not limited to that.

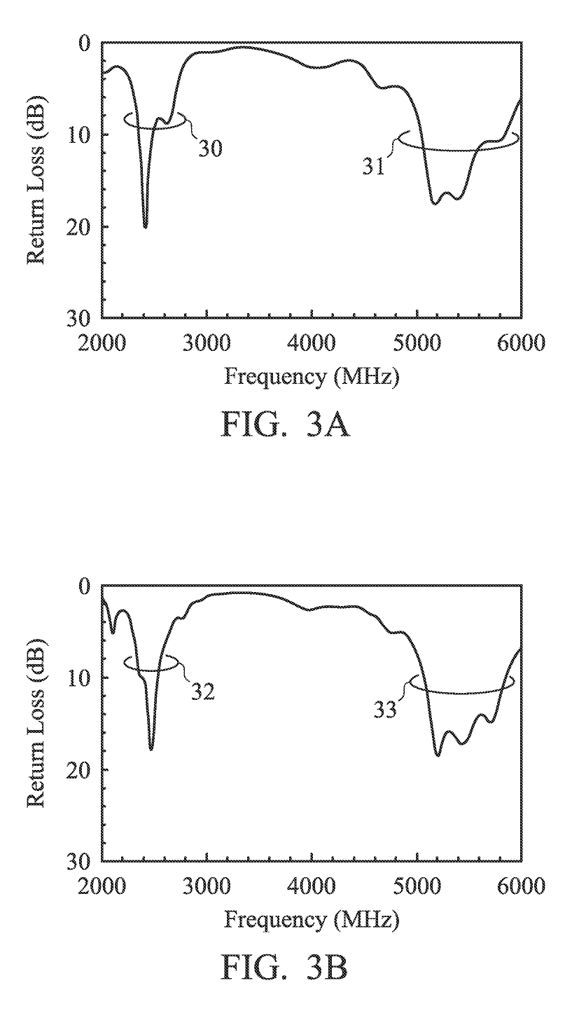

FIG. 3A is a diagram for illustrating return loss of the communication device 100 as shown in FIG. 1A according to the first embodiment of the invention. When the upper cover 11 is substantially perpendicular to the lower cover 12 of the communication device 100 (i.e., the communication device 100 is opened), the antenna element 10 covers a first band 30 and a second band 31. The first band 30 is mainly formed by a resonant mode generated by the closed resonant path of the second radiating element 22, and the second band 31 is mainly formed by a resonant mode generated by the first radiating element 21. The first band 30 and the second band 31 each cover at least one communication band. In a preferred embodiment, the first band 30 covers a 2.4 GHz WLAN band in which the antenna efficiency is approximately from 88% to 92% (including mismatching loss), and the second band 31 covers a 5.2/5.8 GHz WLAN band in which the antenna efficiency is approximately from 85% to 95% (including mismatching loss). In an embodiment, the upper cover 11 and the lower cover 12 each has a length of about 320 mm and a width of about 200 mm, which are reasonable sizes for a notebook with a 13-inch monitor. The antenna element 10 has a length of about 27 mm and a width of about 6 mm, and the antenna element 10 may be printed on a dielectric substrate 24 which has a thickness of about 0.8 mm. The antenna element 10 has a height of about 6 mm, and it is easy to mount the antenna element 10 between the first edge 14 of the upper cover 11 and the second edge 15 of the lower cover 12.

FIG. 3B is a diagram for illustrating return loss of the communication device 100 as shown in FIG. 1B according to the first embodiment of the invention. When the upper cover 11 is substantially parallel to the lower cover 12 of the communication device 100 (i.e., the communication device 100 is closed), the antenna element 10 covers a third band 32 and a fourth band 33. Note that the frequency range of the third band 32 and the fourth band 33 is almost the same as that of the first band 30 and the second band 31 as shown in FIG. 3A. Therefore, no matter whether the communication device is opened or closed, the radiation performances of the antenna element 10 are similar.

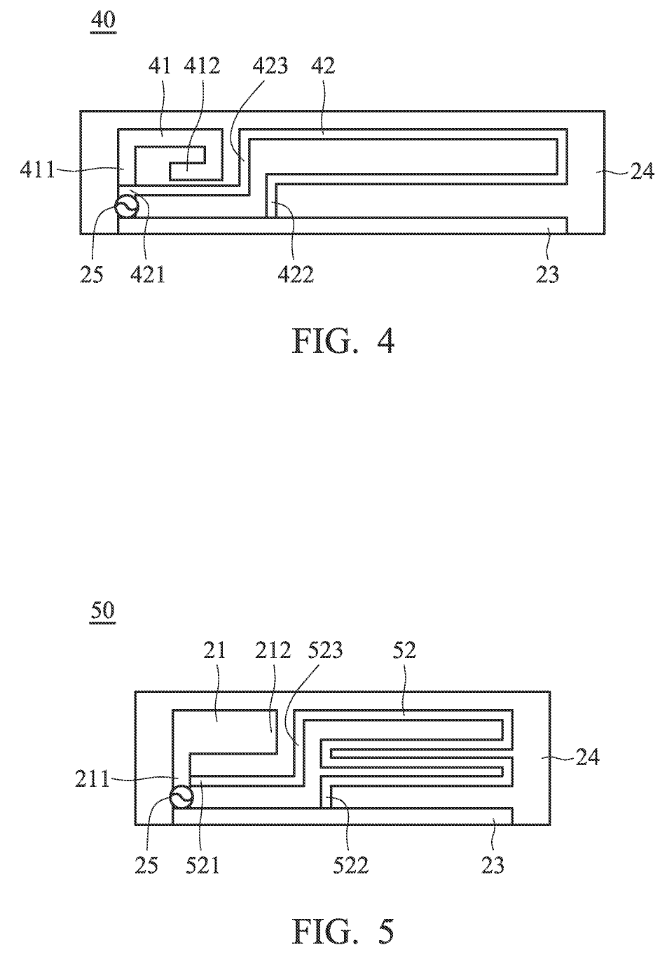

FIG. 4 is a diagram for illustrating an antenna element 40 of the communication device 100 according to a second embodiment of the invention. The difference between the second embodiment and the first embodiment is that a first radiating element 41 of the antenna element 40 has a different shape. In the second embodiment, the first radiating element 41 further has an open end 412 which extends into an interior of the first radiating element 41 so as to further reduce the size of the antenna element 40. The other structures of the antenna element 40 (including the ground element 23 and the second radiating element 42) are similar to those of the antenna element 10 in the first embodiment. Note that the second embodiment and the first embodiment have similar operating principles such that they have similar radiation performances.

FIG. 5 is a diagram for illustrating an antenna element 50 of the communication device 100 according to a third embodiment of the invention. The difference between the third embodiment and the first embodiment is that a second radiating element 52 of the antenna element 50 has a plurality of bending structures to increase the length of the closed resonant path to further reduce the size of the antenna element 50. The other structures of the antenna element 50 (including the ground element 23 and the first radiating element 21) are similar to those of the antenna element 10 in the first embodiment. Note that the third embodiment and the first embodiment have similar operating principles such that they have similar radiation performances.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device with an upper cover and a lower cover, comprising:
a conductive housing, comprising a first conductive surface and a second conductive surface, wherein the first conductive surface is disposed on a surface of the upper cover, the second conductive surface is disposed on a surface of the lower cover, the first conductive surface and the second conductive surface are coupled to each other, and a first edge of the first conductive surface is adjacent to a second edge of the second conductive surface; and
an antenna element, disposed substantially between the first edge and the second edge, wherein the antenna element is excited to form a first band and a second band, and the antenna element comprises:
a ground element, coupled to the second conductive surface;
a first radiating element, excited to generate at least one resonant mode in the second band, wherein one end of the first radiating element is coupled to a signal source; and
a second radiating element, wherein one end of the second radiating element is coupled to the signal source and to the first radiating element, and the other end of the second radiating element is a grounding end coupled to the ground element such that the antenna element provides a closed resonant path excited to generate at least one resonant mode in the first band.

2. The communication device as claimed in claim 1, wherein the first radiating element is a monopole antenna.

3. The communication device as claimed in claim 1, wherein the first radiating element is disposed outside the closed resonant path, and the first radiating element substantially extends a distance away from the ground element and then extends toward a portion of the second radiating element, wherein the portion of the second radiating element is substantially perpendicular to the ground element.

4. The communication device as claimed in claim 1, wherein a length of the closed resonant path is approximately equal to 0.5 wavelength of a frequency in the first band.

5. The communication device as claimed in claim 1, wherein a portion of the second conductive surface is substantially perpendicular to a plane on which the lower cover is positioned.

6. The communication device as claimed in claim 1, wherein the first radiating element and the second radiating element are disposed on a same plane.

7. The communication device as claimed in claim 1, wherein the antenna element is a planar antenna disposed on a surface of a dielectric substrate.

8. The communication device as claimed in claim 1, wherein the antenna element is disposed on a surface of a dielectric substrate, and the surface of the dielectric substrate is a smooth curved surface.

9. The communication device as claimed in claim 1, wherein the first radiating element further comprises an open end extending into an interior of the first radiating element to further reduce a size of the antenna element.

10. The communication device as claimed in claim 1, wherein the second radiating element of the antenna element comprises a plurality of bending structures to increase a length of the closed resonant path to further reduce a size of the antenna element.
